(19) United States
(12) Patent Application Publication
(10) Pub. No.: US 2025/0382016 A1
(43) Pub. Date: Dec. 18, 2025

(54) VEHICLE BODY STRUCTURE

(71) Applicant: MAZDA MOTOR CORPORATION, Hiroshima (JP)

(72) Inventor: Tsuneki SHIMANAKA, Hiroshima (JP)

(73) Assignee: MAZDA MOTOR CORPORATION, Hiroshima (JP)

(21) Appl. No.: 19/235,732

(22) Filed: Jun. 12, 2025

(30) Foreign Application Priority Data
Jun. 17, 2024 (JP) 2024-097320

(51) Int. Cl. B62D 25/08; B62D 21/15; B62D 25/20

(52) U.S. Cl. CPC B62D 25/088; B62D 21/152; B62D 25/20

(57) ABSTRACT

A vehicle body structure includes a vehicle body frame member that is integrally molded by casting in a state where a right suspension tower portion and a left suspension tower portion are coupled by an intermediate portion. The vehicle body frame member includes a coupling member that extends in a left-right direction at a position away from the intermediate portion by a predetermined distance in a vehicle front-rear direction or an up-down direction and couples a right side and a left side of the vehicle body frame member.

### CROSS-REFERENCE TO RELATED APPLICATION

The present application claims priority to Japanese Patent Application 2024-097320, filed Jun. 17, 2024, the entire contents of which are incorporated herein by reference.

### BACKGROUND

### Field

The present disclosure relates to a vehicle body structure of an automobile, for example.

### Description of the Related Art

For example, in a rear portion of an automobile, a suspension tower portion, to which an upper portion of a damper of a suspension device is attached, is provided on each of left and right sides. Patent Literature 1 discloses that a reinforcing member that includes a suspension tower portion is integrally molded by aluminum die casting.

### Citation List

### [Patent Literature]

[Patent Literature 1] JP2020-44885A

### SUMMARY

Here, from a viewpoint of reducing the number of components of a vehicle body, it is considered to obtain a frame member in a rear portion of the vehicle body by coupling a right suspension tower portion and a left suspension tower portion by a coupling portion and, in such a state, integrally molding those by casting.

However, the damper is a member that is long in an up-down direction, and secure an has to extension/contraction stroke amount in the up-down direction, and accordingly, a dimension of the suspension tower portion in the up-down direction becomes long. When the dimension of the suspension tower portion in the up-down direction is increased, it is difficult to secure rigidity only by coupling using the coupling portion.

The present disclosure has been made in view of such a point, and an object thereof is to improve rigidity of a vehicle body frame member that is integrally molded in a state where left and right suspension tower portions are coupled by an intermediate portion in a vehicle width direction.

### Solution to Problem

In order to achieve the above object, an aspect of the present disclosure can assume a vehicle body structure including a vehicle body frame member that is integrally molded by casting in a state where a right suspension tower portion and a left suspension tower portion are coupled by an intermediate portion in a vehicle width direction. The vehicle body frame member includes a coupling member that extends in a left-right direction at a position away from the intermediate portion by a predetermined distance in a vehicle front-rear direction or an up-down direction and couples a right side and a left side of the vehicle body frame member.

According to this configuration, since the right suspension tower portion and the left suspension tower portion are integrally molded via the intermediate portion in the vehicle body frame member, the number of components of the vehicle body frame member is reduced. In addition, since the right side and the left side of the vehicle body frame member are coupled by the different coupling member from the intermediate portion, the right suspension tower portion and the left suspension tower portion can be coupled at plural positions by the intermediate portion and the coupling member. In addition thereto, since the coupling member and the intermediate portion are spaced apart in the vehicle front-rear direction and the up-down direction, a reinforcing effect by providing the coupling member is improved.

A right coupling portion, to which a right side of the coupling member can be coupled, may be provided in an upper portion of the right suspension tower portion. In addition, a left coupling portion, to which a left side of the coupling member can be coupled, may be provided in an upper portion of the left suspension tower portion. According to this configuration, the right side and the left side of the coupling member can be fixed firmly to the upper portion of the right suspension tower portion and the upper portion of the left suspension tower portion.

The right suspension tower portion may be provided with a right damper attachment portion, to which an upper portion of a right damper of a suspension device is attached. In this case, the right coupling portion can be provided at a position that is separated upward from the right damper attachment portion. The left suspension tower portion may be provided with a left damper attachment portion, to which an upper portion of a left damper of the suspension device is attached. In this case, the left coupling portion can be provided at a position that is separated upward from the left damper attachment portion.

According to this configuration, since the coupling member can be positioned above the damper attachment portion, it is possible to secure a long distance from the intermediate portion. This further enhances the reinforcing effect by providing the intermediate portion and the coupling member.

The coupling member may include: an upper coupling member that couples the upper portion of the right suspension tower portion and the upper portion of the left suspension tower portion; and a lower coupling member that couples a lower portion of the right suspension tower portion and a lower portion of the left suspension tower portion.

According to this configuration, since the upper portions and the lower portions of the right suspension tower portion and the left suspension tower portion can be coupled to each other, rigidity of the vehicle body frame member can further be improved.

The upper coupling member may be separated rearward in a vehicle from the intermediate portion, and the lower coupling member may be separated forward in the vehicle from the intermediate portion. According to this configuration, the lower coupling member, the intermediate portion, and the upper coupling member are arranged in this order from the front to the rear of the vehicle. In this way, the rigidity of the vehicle body frame member can further be increased.

The vehicle body structure may include: a floor panel formed with a tunnel portion that bulges upward in a central portion in the left-right direction and extends in the vehicle front-rear direction; a right cross member that extends from a right side of the floor panel to a right side surface of the tunnel portion in an upper surface of the floor panel; a left cross member that extends from a left side of the floor panel to a left side surface of the tunnel portion in the upper surface of the floor panel; and a tunnel member that extends across the tunnel portion in the left-right direction in a lower surface of the floor panel. A right side of the right cross member can be coupled to a lower portion of the right suspension tower portion, and a left side of the left cross member can be coupled to a lower portion of the left suspension tower portion. Furthermore, a right side of the tunnel member can be coupled to a left side of the right cross member, and a left side of the tunnel member can be coupled to a right side of the left cross member. In this case, the right cross member, the left cross member, and the tunnel member can constitute the coupling member. That is, the right cross member, the left cross member, and the tunnel member for increasing rigidity of the floor panel can be used to couple the right side and the left side of the vehicle body frame member. In addition, by using the right cross member, the left cross member, and the tunnel member, the vehicle body frame member can be coupled to the tunnel portion having high rigidity. Thus, this can also increase the rigidity of the vehicle body frame member.

A vehicle rear portion of the tunnel portion may be connected to the intermediate portion. In this way, the intermediate portion can be coupled to the tunnel portion having the high rigidity, and thus the rigidity of the vehicle body frame member can further be increased.

### Advantages

As it has been described so far, since the coupling member that couples the right side and the left side of the vehicle body frame member is provided at the position away from the intermediate portion that couples the right suspension tower portion and the left suspension tower portion, the rigidity of the vehicle body frame member can be improved.

### BRIEF DESCRIPTION OF THE DRAWINGS

The scope of the present disclosure is best understood from the following detailed description of exemplary embodiments when read in conjunction with the accompanying drawings.

FIG. 1 is a side view of an automobile that has a vehicle body structure according to an embodiment of the present disclosure.

FIG. 2 is a plan view of the vehicle body structure.

FIG. 3 is a bottom view of the vehicle body structure.

FIG. 4 is a cross-sectional view that is taken along line IV-IV in FIG. 2.

FIG. 5 is a perspective view of a rear frame member.

FIG. 6 is a plan view of the rear frame member.

FIG. 7 is a front view of the rear frame member.

FIG. 8 is a view in which a right portion of the rear frame member is viewed from an obliquely upper left side.

FIG. 9 is a left view of the right portion of the rear frame member.

### DETAILED DESCRIPTION

A detailed description will hereinafter be made on an embodiment of the disclosure with reference to the drawings. It should be noted that the following description of the preferred embodiment is merely illustrative in nature and is not intended to limit the disclosure, application subjects thereof, or application thereof.

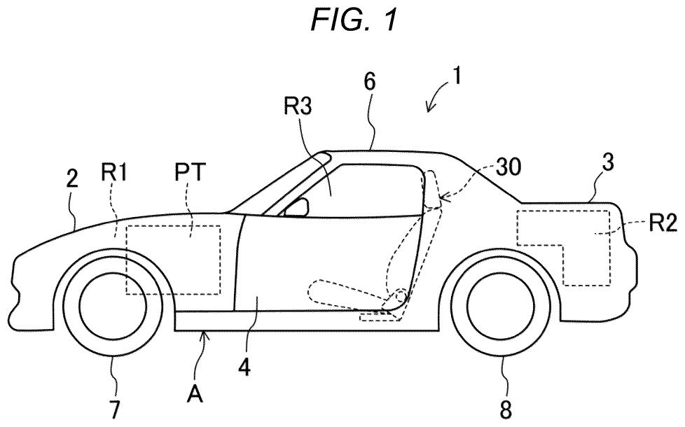

FIG. 1 is a side view of an automobile 1 that has a vehicle body structure A according to the embodiment of the disclosure. In the description of this embodiment, a vehicle front side will simply be referred to as “front”, a vehicle rear side will simply be referred to as “rear”, a vehicle right side will simply be referred to as “right”, and a vehicle left side will simply be referred to as “left”. A vehicle left-right direction is a vehicle width direction.

The automobile 1 is a passenger automobile, for example, and may be an automobile of a coupe type, a hatchback type, or a sedan type, for example. The automobile 1 may be an automobile that is equipped with an internal combustion engine that generates a driving force transmitted to drive wheels, may be an electric vehicle that is equipped with a travel motor that generates a driving force transmitted to drive wheels, or may be a hybrid vehicle that generates a driving force transmitted to drive wheels by an internal combustion engine and a driving force generation motor. The internal combustion engine and the motor constitute a powertrain PT.

A bonnet hood 2 is provided in a front portion of the automobile 1. A front space R1 in which the powertrain PT is mounted when necessary is provided below the bonnet hood 2. A rear hood 3 is provided in a rear portion of the automobile 1. A rear space R2 capable of accommodating baggage and the like is provided below the rear hood 3. Instead of mounting the powertrain PT in the front space R1, a powertrain may be mounted in the rear space R2. In this case, the front space R1 can be used as a space for accommodating the baggage and the like. Alternatively, the powertrain may be mounted in both the front space R1 and the rear space R2.

A left door 4 and a right door are openably/closably provided in a left portion and a right portion of the automobile 1, respectively. The automobile 1 also includes front wheels 7 and rear wheels 8 on left and right sides. At least one of the front wheel 7 and the rear wheel 8 can be a drive wheel.

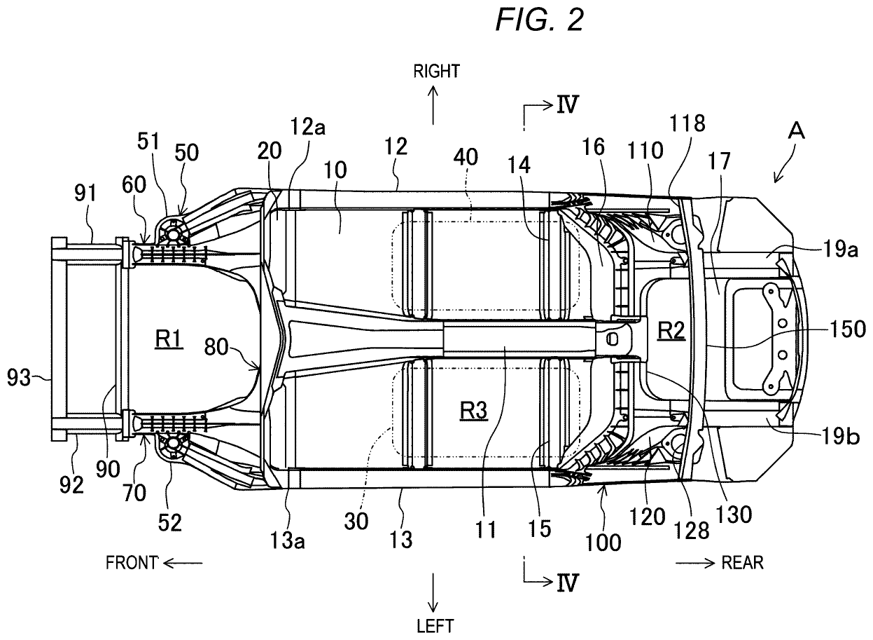

A cabin R3 as a living space for an occupant is provided between the front space R1 and the rear space R2. As illustrated in FIG. 2, the vehicle body structure A includes: a floor panel 10 that forms a floor surface of the cabin R3; and a dash panel 20 that forms a front wall of the cabin R3. The vehicle body structure A of the automobile 1 also includes: an inclined panel 16 that extends upward from a rear end portion of the floor panel 10 and is inclined rearward toward the above; and a rear panel 17 that extends rearward from an upper end portion of the inclined panel 16.

A tunnel portion 11 that bulges upward and extends in a front-rear direction is formed in a central portion of the floor panel 10 in the left-right direction. The automobile 1 further includes: a right side sill 12 that extends in the front-rear direction along a right edge of the floor panel 10; and a left side sill 13 that extends in the front-rear direction along a left edge of the floor panel 10. A right hinge pillar 12a that extends upward is provided in a front portion of the right side sill 12. The right hinge pillar 12a is a member that supports the right door. A left hinge pillar 13a that extends upward is provided in a front portion of the left side sill 13. The left hinge pillar 13a is a member that supports the left door 4.

A front end portion of the tunnel portion 11 is located in a front end portion of the floor panel 10, and a rear end portion of the tunnel portion 11 is located in the rear end portion of the floor panel 10. Thus, the tunnel portion 11 has a shape that continuously extends from the front end portion to the rear end portion of the floor panel 10.

The vehicle body structure A includes: a right cross member 14 that extends from a right side of the floor panel 10 to a right side surface of the tunnel portion 11 on an upper surface of the floor panel 10; and a left cross member 15 that extends from a left side of the floor panel 10 to a left side surface of the tunnel portion 11 on the upper surface of the floor panel 10. In the present embodiment, the two right cross members 14 are spaced apart from each other in the front-rear direction, and the two left cross members 15 are spaced apart from each other in the front-rear direction. The right cross member 14 on a front side and the left cross member 15 on a front side are arranged in a manner to be aligned on the same straight line that extends in the left-right direction. The right cross member 14 on a rear side and the left cross member 15 on a rear side are also arranged in a manner to be aligned on the same straight line that extends in the left-right direction.

Each of the right cross members 14 is formed along the upper surface of the floor panel 10 on a right side of the tunnel portion 11, and is fixed to the upper surface. A right end portion of the right cross member 14 is fixed to a side surface on a vehicle inner side of the right side sill 12 while a left end portion of the right cross member 14 is fixed to the right side surface of the tunnel portion 11.

Each of the left cross members 15 is formed along the upper surface of the floor panel 10 on a left side of the tunnel portion 11, and is fixed to the upper surface. A left end portion of the left cross member 15 is fixed to a side surface on the vehicle inner side of the left side sill 13 while a right end portion of the left cross member 15 is fixed to the left side surface of the tunnel portion 11.

The automobile 1 is a right-hand drive vehicle. Thus, the automobile 1 includes a passenger seat 30 as a left seat (seating) and a driver's seat 40 as a right seat (seating) on the left side and the right side of the tunnel portion 11 on the floor panel 10, respectively. More specifically, the passenger seat 30 is provided on the left side of the tunnel portion 11 on the floor panel 10, and the passenger seat 30 is arranged between the tunnel portion 11 and the left side sill 13. The driver's seat 40 is provided on the right side of the tunnel portion 11 on the floor panel 10, and the driver's seat 40 is arranged between the tunnel portion 11 and the right side sill 12. Thus, the passenger seat 30 and the driver's seat 40 are arranged side by side in the left-right direction in a manner to sandwich the tunnel portion 11.

A lower portion of the driver's seat 40 is attached to the two right cross members 14. A lower portion of the passenger seat 30 is attached to the two left cross members 15. Here, the automobile 1 may be a left-hand drive vehicle. In this case, the driver's seat 40 may be provided on the left side, and the passenger seat 30 may be provided on the right side. Further, a rear seat may be provided behind the driver's seat 40 and the passenger seat 30.

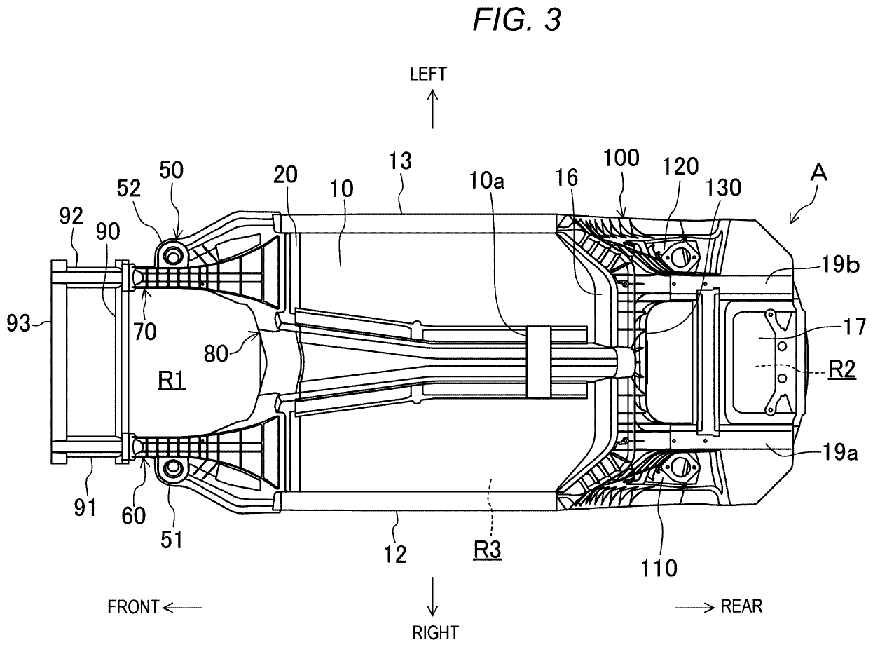

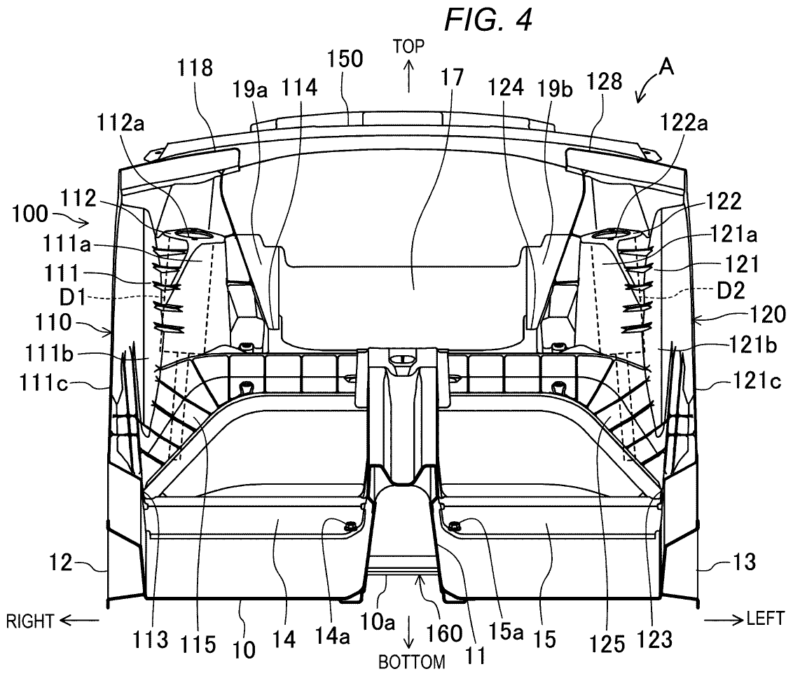

As illustrated in FIG. 3 and FIG. 4, the vehicle body structure A includes a tunnel member 10a that extends across the tunnel portion 11 in the left-right direction on the lower surface of the floor panel 10. The tunnel member 10a is a reinforcing member that is positioned below the right cross member 14 and the left cross member 15 on the rear side and that suppresses deformation of the tunnel portion 11, which is opened downward, to be opened in the left-right direction.

A right side of the tunnel member 10a extends to the right side of the right side surface of the tunnel portion 11, and is in a positional relationship that overlaps a left side of the right cross member 14 in a plan view. The right side of the tunnel member 10a and the left side of the right cross member 14 are fixed to and integrated with the floor panel 10 by a fastening member 14a, for example.

A left side of the tunnel member 10a extends to the left side of the left side surface of the tunnel portion 11, and is in a positional relationship that overlaps a right side of the left cross member 15 in the plan view. The left side of the tunnel member 10a and the right side of the left cross member 15 are fixed to and integrated with the floor panel 10 by a fastening member 15a, for example. That is, the right cross member 14 and the left cross member 15 are coupled via the tunnel member 10a to constitute a reinforcing member.

As illustrated in FIG. 2 and FIG. 3, the dash panel 20 is a member that extends upward and in the left-right direction from the front end portion of the floor panel 10 and that divides the cabin R3 and the front space R1 located on the front side of the cabin R3. The front end portion of the tunnel portion 11 is connected to a central portion in the left-right direction of a lower portion of the dash panel 20.

A front cast member 50 is provided in the front portion of the automobile 1. The front cast member 50 includes a right front side frame 60, a left front side frame 70, a coupling portion 80 that couples the right front side frame 60 and the left front side frame 70, a right front suspension tower portion 51, and a left front suspension tower portion 52.

The front space R1 is provided between the right front side frame 60 and the left front side frame 70. The right front side frame 60, the left front side frame 70, and the coupling portion 80 are integrally molded by casting. A rear portion of the left front side frame 70 and a rear portion of the right front side frame 60 are fixed to the dash panel 20. A rear portion of the coupling portion 80 is fixed to front portions of the dash panel 20 and the tunnel portion 11. When the right front side frame 60, the left front side frame 70, and the coupling portion 80 are fixed to the dash panel 20 and the tunnel portion 11, any of various fixing methods, such as fixing by welding and fastening fixing using a fastening member (including, a self-piercing rivet, for example), can be applied. Of these fixing methods, any one of the fixing methods may be employed, or any two or more of the fixing methods may be used in combination.

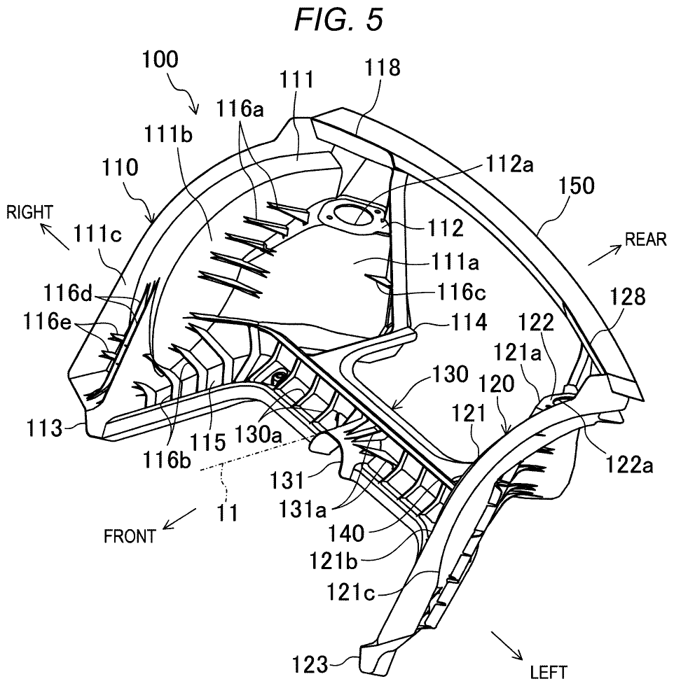

The vehicle body structure A includes a rear vehicle body frame member 100 provided on a rear portion. More specifically, the rear vehicle body frame member 100 that is integrally molded by casting is provided above the inclined panel 16. The rear vehicle body frame member 100 includes a right rear suspension tower portion 110, a left rear suspension tower portion 120, and an intermediate portion 130. As illustrated in FIG. 5 to FIG. 7, the intermediate portion 130 is a portion that is provided in an intermediate portion in the left-right direction of the rear vehicle body frame member 100 and couples the right rear suspension tower portion 110 and the left rear suspension tower portion 120. The right rear suspension tower portion 110 and the left rear suspension tower portion 120 are integrally molded by casting in a state of being coupled by the intermediate portion 130. When the rear vehicle body frame member 100 is manufactured, an aluminum die casting method can be used, for example.

As illustrated in FIG. 2, a front end portion of a right rear frame 19a that extends rearward is connected to a rear portion of the right rear suspension tower portion 110. The right rear frame 19a is arranged on the vehicle inner side of the right side sill 12 and is located above the right side sill 12. In addition, a front end portion of a left rear frame 19b that extends rearward is connected to a rear portion of the left rear suspension tower portion 120. The left rear frame 19b is arranged on the vehicle inner side of the left side sill 13 and is located above the left side sill 13. The rear panel 17 is provided to connect the right rear frame 19a and the left rear frame 19b.

As illustrated in FIG. 4 to FIG. 7, the right rear suspension tower portion 110 has a right wheelhouse portion 111 that forms a wheelhouse of a right rear wheel. The right wheelhouse portion 111 has a concave shape that extends in an up-down direction and the front-rear direction and that is recessed toward the vehicle inner side and the front side. A rear side and a lower side of this right wheelhouse portion 111 are both open, and the right wheelhouse portion 111 thereby has a dome shape.

The right wheelhouse portion 111 includes: a right bulging portion 111a that bulges to the vehicle inner side; and a right plate portion 111b that extends in the up-down direction and the front-rear direction from an upper portion to a front portion of the right bulging portion 111a. A right damper attachment portion 112 is provided near the upper portion of the right bulging portion 111a. The right damper attachment portion 112 is a plate-shaped portion to which an upper portion of a damper D1 provided in a rear suspension device is attached, and extends in the front-rear direction and the left-right direction. An opening 112a is formed in the right damper attachment portion 112.

A right flange portion 111c is formed in a peripheral edge portion of the right plate portion 111b. The right flange portion 111c continuously extends from an upper portion to a lower portion via a front portion of the right wheelhouse portion 111. A right front connection portion 113 that is connected to a rear end portion of the right side sill 12 is formed in a front lower portion of the right wheelhouse portion 111. In addition, a right rear connection portion 114 that is connected to a rear end portion of the right rear frame 19a is formed in a rear lower portion of the right wheelhouse portion 111. The right rear connection portion 114 is located on the vehicle inner side and above the right front connection portion 113.

A right load transmission portion 115 that extends from the right front connection portion 113 to the right rear connection portion 114 is provided in the lower portion of the right wheelhouse portion 111. The right load transmission portion 115 is inclined to be located outward in the vehicle and downward to the front.

The left rear suspension tower portion 120 and the right rear suspension tower portion 110 have a bilaterally symmetrical structure. More specifically, when an imaginary line that extends in the front-rear direction through a center of the automobile 1 in the left-right direction is set as a center of the symmetry, the left rear suspension tower portion 120 is line-symmetric with the right rear suspension tower portion 110, and the right rear suspension tower portion 110 is line-symmetric with the left rear suspension tower portion 120.

That is, the left rear suspension tower portion 120 has a left wheelhouse portion 121 that forms a wheelhouse of the left rear wheel 8 (illustrated in FIG. 1). The left wheelhouse portion 121 has a concave shape that extends in the up-down direction and the front-rear direction and that is recessed toward the vehicle inner side and the front side. A rear side and a lower side of this left wheelhouse portion 121 are both open, and the left wheelhouse portion 121 thereby has a dome shape.

The left wheelhouse portion 121 includes: a left bulging portion 121a that bulges to the vehicle inner side; and a left plate portion 121b that extends in the up-down direction and the front-rear direction from an upper portion to a front portion of the left bulging portion 121a. A left damper attachment portion 122, to which an upper portion of a right damper D2 provided in the rear suspension device is attached, is provided near the upper portion of the left bulging portion 121a. The left damper attachment portion 122 has an opening 122a.

A left flange portion 121c is formed in a peripheral edge portion of the left plate portion 121b. The left flange portion 121c continuously extends from an upper portion to a lower portion via a front portion of the left wheelhouse portion 121. A left front connection portion 123 that is connected to a rear end portion of the left side sill 13 is formed in a front lower portion of the left wheelhouse portion 121. In addition, a left rear connection portion 124 that is connected to a rear end portion of the left rear frame 19b is formed in a rear lower portion of the left wheelhouse portion 121. The left rear connection portion 124 is located on the vehicle inner side and above the left front connection portion 123.

A left load transmission portion 125 that extends from the left front connection portion 123 to the left rear connection portion 124 is provided in the lower portion of the left wheelhouse portion 121. The left load transmission portion 125 is inclined to be located outward in the vehicle and downward to the front.

Accordingly, for example, an impact load during a rear collision is input to the right wheelhouse portion 111 via the right rear frame 19a. The impact load that has been input to the right wheelhouse portion 111 is transmitted to the right side sill 12 via the right rear connection portion 114, the right load transmission portion 115, and the right front connection portion 113. The impact load during the rear collision is input to the left wheelhouse portion 121 via the left rear frame 19b. The impact load that has been input to the left wheelhouse portion 121 is transmitted to the left side sill 13 via the left rear connection portion 124, the left load transmission portion 125, and the left front connection portion 123.

Just as described, since the rear vehicle body frame member 100 is a member that receives the impact load during the rear collision and transmits it to the right side sill 12 and the left side sill 13, it is necessary to increase rigidity to the input of the impact load. Thus, one or more ribs are integrally molded with the rear vehicle body frame member 100.

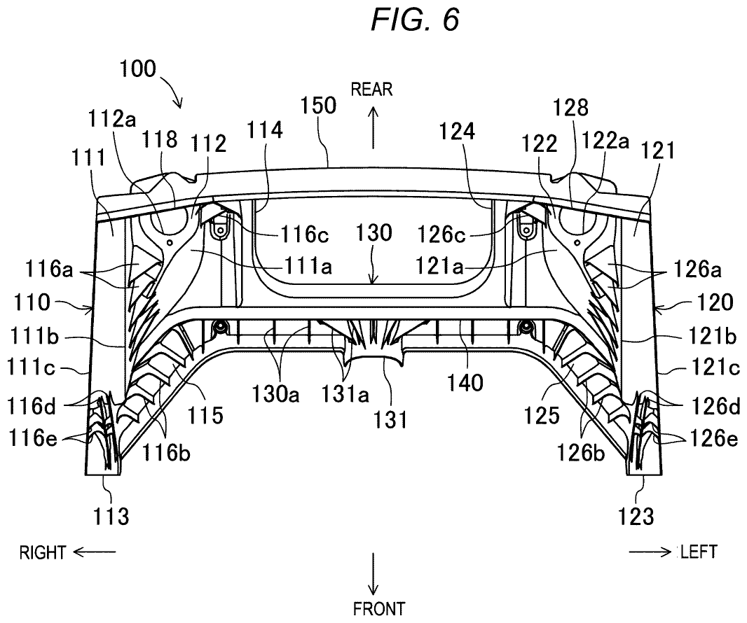

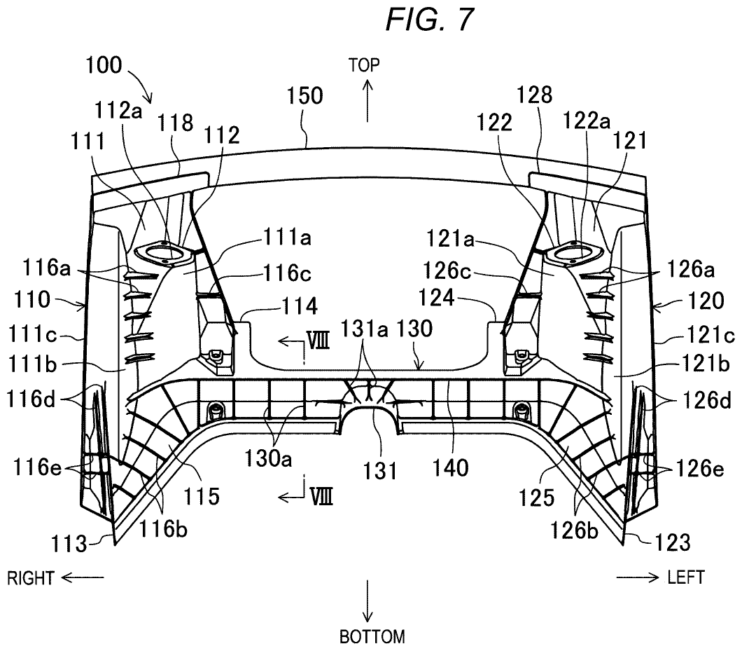

As illustrated in FIG. 5 to FIG. 7, a first right inner rib 116a, a second right inner rib 116b, a third right inner rib 116c, a fourth right inner rib 116d, and a fifth right inner rib 116e are integrally molded on the vehicle inner side of the right wheelhouse portion 111. Although the detailed description is omitted, similar to the right wheelhouse portion 111, plural ribs 126a to 126e (illustrated in FIG. 6 and FIG. 7) are integrally molded on the vehicle inner side of the left wheelhouse portion 121.

As illustrated in FIG. 5 and FIG. 6, the intermediate portion 130 extends in the left-right direction from an intermediate portion in the front-rear direction in a lower portion of the right rear suspension tower portion 110 to an intermediate portion in the front-rear direction in a lower portion of the left rear suspension tower portion 120. Plural first lower ribs 130a, each of which protrudes forward and extends in the up-down direction, are provided on a front surface of the intermediate portion 130 at spaced intervals from each other in the left-right direction. In addition, a curved plate portion 131 that is curved upward is provided in a center portion in the left-right direction of the intermediate portion 130. On an upper surface of the curved plate portion 131, plural second lower ribs 131a, each of which protrudes upward and extends forward, are provided at spaced intervals from each other in a circumferential direction of the curved plate portion 131.

A rear portion of the tunnel portion 11 of the floor panel 10 is connected to the curved plate portion 131 of the intermediate portion 130. In this way, the intermediate portion 130 can be coupled to the tunnel portion 11 having high rigidity.

The rear vehicle body frame member 100 includes a long rib 140 that continues from the right rear suspension tower portion 110 to the intermediate portion 130 and continues to the left rear suspension tower portion 120. A right portion of the long rib 140 is integrally molded with the front portions of the right bulging portion 111a and the right plate portion 111b. A left portion of the long rib 140 is integrally molded with front portions of the left bulging portion 121a and the left plate portion 121b.

The vehicle body structure A includes an upper coupling member 150 that extends in the left-right direction at a position away from the intermediate portion 130 by a predetermined distance in the front-rear direction or the up-down direction and that couples a right side and a left side of the vehicle body frame member 100. The upper coupling member 150 in the present embodiment is a member that couples the upper portion of the right rear suspension tower portion 110 and the upper portion of the left rear suspension tower portion 120, and can be referred to as a deck member or the like. The upper coupling member 150 may be formed of, for example, a press-molded plate material or may be formed of an extruded member.

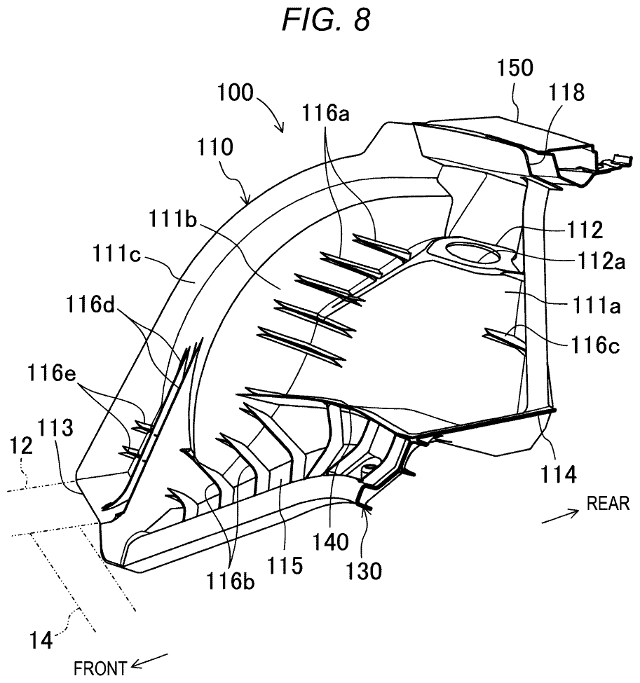

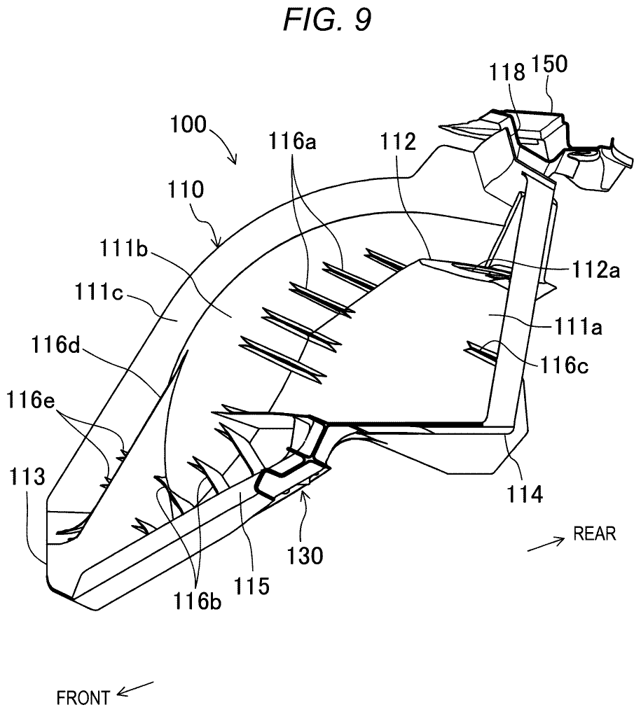

In addition, the upper coupling member 150 is separated upward from the intermediate portion 130 and is also separated rearward from the intermediate portion 130. That is, as illustrated in FIG. 8 and FIG. 9, a right coupling portion 118 to which a right side of the upper coupling member 150 can be coupling is provided in the upper portion of the right rear suspension tower portion 110. The right coupling portion 118 has a plate shape that is separated upward from the right damper attachment portion 112 and extends in the left-right direction. The right side of the upper coupling member 150 is fixed to the right coupling portion 118 by welding or a fastening member.

In addition, a left coupling portion 128, to which a left side of the upper coupling member 150 can be coupled, is provided in the upper portion of the left rear suspension tower portion 120. The left coupling portion 128 has a plate shape that is separated upward from the left damper attachment portion 122 and extends in the left-right direction. The left side of the upper coupling member 150 is fixed to the left coupling portion 128 by welding or a fastening member.

The upper coupling member 150 may be a header that is arranged at a position separated upward from the upper portions of the right rear suspension tower portion 110 and the left rear suspension tower portion 120.

As illustrated in FIG. 4, the right cross member 14, the left cross member 15, and the tunnel member 10a are lower coupling members 160 that couple the lower portion of the right rear suspension tower portion 110 and the lower portion of the left rear suspension tower portion 120. That is, since a right side of the right cross member 14 is fixed to the right side sill 12, and the right front connection portion 113, which is formed in the lower portion of the right rear suspension tower portion 110, is connected to the right side sill 12, the right side of the right cross member 14 is coupled to the right front connection portion 113 of the right rear suspension tower portion 110 via the right side sill 12. In addition, since a left side of the left cross member 15 is fixed to the left side sill 13, and the left front connection portion 123, which is formed in the lower portion of the left rear suspension tower portion 120, is connected to the left side sill 13, the left side of the left cross member 15 is coupled to the left front connection portion 123 of the left rear suspension tower portion 120 via the left side sill 13. Alternatively, the right side of the right cross member 14 may directly be coupled to the lower portion of the right rear suspension tower portion 110, or the left side of the left cross member 15 may directly be coupled to the lower portion of the left rear suspension tower portion 120.

The lower coupling member 160 is separated downward from the intermediate portion 130 and is also separated forward from the intermediate portion 130. Thus, in a front view, the intermediate portion 130 is arranged between the upper coupling member 150 and the lower coupling member 160. Also, in the plan view, the intermediate portion 130 is arranged between the upper coupling member 150 and the lower coupling member 160.

### (Operational Effects of Embodiment)

As it has been described so far, in the present embodiment, the right rear suspension tower portion 110 and the left rear suspension tower portion 120 are integrally molded by casting via the intermediate portion 130. Accordingly, the right rear suspension tower portion 110, the left rear suspension tower portion 120, and the intermediate portion 130 serve as one component, and thus the number of components of the rear vehicle body frame member 100 is reduced.

In addition, the right rear suspension tower portion 110 and the left rear suspension tower portion 120 of the rear vehicle body frame member 100 are coupled by the upper coupling member 150 and the lower coupling member 160. Since the upper coupling member 150 is separated upward and rearward from the intermediate portion 130, and the lower coupling member 160 is separated downward and forward from the intermediate portion 130, portions of the right rear suspension tower portion 110 and the left rear suspension tower portion 120 that are separated from each other can be coupled by a highly rigid member. In this way, the rigidity of the rear vehicle body frame member 100 can be improved.

Furthermore, since the right cross member 14, to which the driver's seat 40 is attached, and the left cross member 15, to which the passenger seat 30 is attached, are used to couple the right rear suspension tower portion 110 and the left rear suspension tower portion 120, a member for attaching the seat and a member for reinforcing the rear vehicle body frame member 100 can be a common member, and an increase in the number of the components can thereby be suppressed. Alternatively, a dedicated member for coupling the right rear suspension tower portion 110 and the left rear suspension tower portion 120 may be provided.

The above-described embodiment is merely illustrative in all respects, and should not be construed in a limited manner. Furthermore, all modifications and variations that fall within the scope equivalent to the claims are intended to fall within the scope of the disclosure. For example, the upper coupling member 150 may couple the right damper attachment portion 112 and the left damper attachment portion 122. Alternatively, one of the upper coupling member 150 and the lower coupling member 160 may be omitted. The upper coupling member 150 may integrally be molded with the right rear suspension tower portion 110 and the left rear suspension tower portion 120 by casting. The lower coupling member 160 may integrally be molded with the right rear suspension tower portion 110 and the left rear suspension tower portion 120 by casting. The lower coupling member 160 may be formed of a single member that extends in the left-right direction without being formed of the right cross member 14, the left cross member 15, and the tunnel member 10a. The lower coupling member 160 may be formed of a press-molded plate material or may be an extruded member. The lower coupling member 160 may integrally be molded with the right rear suspension tower portion 110 and the left rear suspension tower portion 120 by casting.

The disclosure can also be applied to a front vehicle body structure of the automobile 1. For example, a coupling member that couples the right front suspension tower portion 51 and the left front suspension tower portion 52 of the front cast member 50 may be provided. In this case, the coupling portion 80 of the front cast member 50 is a portion corresponding to the intermediate portion.

### Industrial Applicability

As it has been described so far, the present disclosure can be used for a vehicle body frame member of an automobile, for example.

### REFERENCE SIGNS LIST

1: automobile
10: floor panel
10a: tunnel member
11: tunnel portion
14: right cross member
15: left cross member
110: right rear suspension tower portion
112: right damper attachment portion
118: right coupling portion
120: left rear suspension tower portion
122: left damper attachment portion
128: left coupling portion
130: intermediate portion
150: upper coupling member
160: lower coupling member
D1, D2: Damper

1. A vehicle body structure including a vehicle body frame that is integrally molded by casting in a state where a right suspension tower portion and a left suspension tower portion are coupled by an intermediate portion in a vehicle width direction, the vehicle body structure comprising:
a coupling structure that extends in a left-right direction at a position away from the intermediate portion by a predetermined distance in a vehicle front-rear direction and an up-down direction and couples a right side and a left side of the vehicle body frame, wherein
the coupling structure includes:
an upper coupling structure that couples an upper portion of the right suspension tower portion and an upper portion of the left suspension tower portion; and
a lower coupling structure that couples a lower portion of the right suspension tower portion and a lower portion of the left suspension tower portion.

2. The vehicle body structure according to claim 1, wherein
the upper coupling structure is separated rearward in a vehicle from the intermediate portion, and
the lower coupling structure is separated forward in the vehicle from the intermediate portion.

3. The vehicle body structure according to claim 2, further comprising:
a floor panel formed with a tunnel portion that bulges upward in a central portion in the left-right direction and extends in the vehicle front-rear direction, wherein
a vehicle rear portion of the tunnel portion is connected to the intermediate portion.

4. The vehicle body structure according to claim 1, wherein
the right suspension tower portion is provided with a right damper attachment portion, to which an upper portion of a right damper of a suspension device is attached, and the right coupling portion is separated upward from the right damper attachment portion, and
the left suspension tower portion is provided with a left damper attachment portion, to which an upper portion of a left damper of the suspension device is attached, and the left coupling portion is separated upward from the left damper attachment portion.

5. The vehicle body structure according to claim 4, wherein
the coupling structure includes:
an upper coupling structure that couples an upper portion of the right suspension tower portion and an upper portion of the left suspension tower portion; and
a lower coupling structure that couples a lower portion of the right suspension tower portion and a lower portion of the left suspension tower portion.

6. The vehicle body structure according to claim 1, further comprising:
a floor panel formed with a tunnel portion that bulges upward in a central portion in the left-right direction and extends in the vehicle front-rear direction;
a right cross structure that extends from a right side of the floor panel to a right side surface of the tunnel portion in an upper surface of the floor panel;
a left cross structure that extends from a left side of the floor panel to a left side surface of the tunnel portion in the upper surface of the floor panel; and
a tunnel structure that extends across the tunnel portion in the left-right direction in a lower surface of the floor panel, wherein
a right side of the right cross structure is coupled to a lower portion of the right suspension tower portion,
a left side of the left cross structure is coupled to a lower portion of the left suspension tower portion,
a right side of the tunnel structure is coupled to a left side of the right cross structure,
a left side of the tunnel structure is coupled to a right side of the left cross structure, and
the right cross structure, the left cross structure, and the tunnel structure constitute the coupling structure.

7. A vehicle body structure including a vehicle body frame that is integrally molded by casting in a state where a right suspension tower portion and a left suspension tower portion are coupled by an intermediate portion in a vehicle width direction, the vehicle body structure comprising:
a coupling structure that extends in a left-right direction at a position away from the intermediate portion by a predetermined distance in a vehicle front-rear direction and an up-down direction and couples a right side and a left side of the vehicle body frame;
a right coupling portion, to which a right side of the coupling structure can be coupled, is provided in an upper portion of the right suspension tower portion;
a left coupling portion, to which a left side of the coupling structure can be coupled, is provided in an upper portion of the left suspension tower portion;
the right suspension tower portion is provided with a right damper attachment portion, to which an upper portion of a right damper of a suspension device is attached, and the right coupling portion is separated upward from the right damper attachment portion;
the left suspension tower portion is provided with a left damper attachment portion, to which an upper portion of a left damper of the suspension device is attached, and the left coupling portion is separated upward from the left damper attachment portion;
the coupling structure includes:
an upper coupling structure that couples the upper portion of the right suspension tower portion and the upper portion of the left suspension tower portion;
a lower coupling structure that couples a lower portion of the right suspension tower portion and a lower portion of the left suspension tower portion;
the upper coupling structure is separated rearward in a vehicle from the intermediate portion;
the lower coupling structure is separated forward in the vehicle from the intermediate portion;
a floor panel formed with a tunnel portion that bulges upward in a central portion in the left-right direction and extends in the vehicle front-rear direction;
a right cross structure that extends from a right side of the floor panel to a right side surface of the tunnel portion in an upper surface of the floor panel;
a left cross structure that extends from a left side of the floor panel to a left side surface of the tunnel portion in the upper surface of the floor panel;
a tunnel structure that extends across the tunnel portion in the left-right direction in a lower surface of the floor panel, wherein
a right side of the right cross structure is coupled to the lower portion of the right suspension tower portion,
a left side of the left cross structure is coupled to the lower portion of the left suspension tower portion,
a right side of the tunnel structure is coupled to a left side of the right cross structure,
a left side of the tunnel structure is coupled to a right side of the left cross structure,
the right cross structure, the left cross structure, and the tunnel structure constitute the coupling structure, and
a vehicle rear portion of the tunnel portion is connected to the intermediate portion.

8. The vehicle body structure according to claim 1, wherein
the upper coupling structure is separated rearward in a vehicle from the intermediate portion.

9. The vehicle body structure according to claim 2, further comprising:
a floor panel formed with a tunnel portion that bulges upward in a central portion in the left-right direction and extends in the vehicle front-rear direction.

10. The vehicle body structure according to claim 1, wherein
the right suspension tower portion is provided with a right damper attachment portion, to which an upper portion of a right damper of a suspension device is attached, and the right coupling portion is separated upward from the right damper attachment portion.

11. The vehicle body structure according to claim 4, wherein
the coupling structure includes:
an upper coupling structure that couples an upper portion of the right suspension tower portion and an upper portion of the left suspension tower portion.

12. The vehicle body structure according to claim 1, further comprising:
a floor panel formed with a tunnel portion that bulges upward in a central portion in the left-right direction and extends in the vehicle front-rear direction.

13. The vehicle body structure according to claim 1, further comprising:
a floor panel formed with a tunnel portion that bulges upward in a central portion in the left-right direction and extends in the vehicle front-rear direction; and
a right cross structure that extends from a right side of the floor panel to a right side surface of the tunnel portion in an upper surface of the floor panel.

14. The vehicle body structure according to claim 1, further comprising:
a floor panel formed with a tunnel portion that bulges upward in a central portion in the left-right direction and extends in the vehicle front-rear direction;
a right cross structure that extends from a right side of the floor panel to a right side surface of the tunnel portion in an upper surface of the floor panel; and
a left cross structure that extends from a left side of the floor panel to a left side surface of the tunnel portion in the upper surface of the floor panel.

15. The vehicle body structure according to claim 1, further comprising:
a floor panel formed with a tunnel portion that bulges upward in a central portion in the left-right direction and extends in the vehicle front-rear direction;
a right cross structure that extends from a right side of the floor panel to a right side surface of the tunnel portion in an upper surface of the floor panel;
a left cross structure that extends from a left side of the floor panel to a left side surface of the tunnel portion in the upper surface of the floor panel; and
a tunnel structure that extends across the tunnel portion in the left-right direction in a lower surface of the floor panel.
